(19) United States
(12) Patent Application Publication
(10) Pub. No.: US 2019/0367090 A1
(43) Pub. Date: Dec. 5, 2019

(54) Self-configuring Systems

(71) Applicant: Daniel Robert Shepard, Stratham, NH (US)

(72) Inventor: Daniel Robert Shepard, Stratham, NH (US)

(21) Appl. No.: 16/432,146

(22) Filed: Jun. 5, 2019

Related U.S. Application Data
(60) Provisional application No. 62/680,912, filed on Jun. 5, 2018.

(51) Int. Cl. B62D 13/06; H04W 4/02; H04W 4/40

(52) U.S. Cl. CPC B62D 13/06; H04W 4/40; H04W 4/027

(57) ABSTRACT

The present invention relates to entering data into a trailer backup guidance system. In particular, the present invention relates to providing data by auto-configuration to systems for guiding a trailer while backing such as (i) the wheel base of the vehicle, (ii) the length of the trailer, (iii) the wheel base of the vehicle measured in units of trailer length, (iv) the ratio of the turning of the steering wheel to the turning of the wheels of the vehicle, and (v) a communication link's address or ID.

### CROSS-REFERENCE TO RELATED APPLICATION

This Utility Patent Application makes reference to and claims the benefit of U.S. Provisional Patent Application 62/680,912 by Shepard titled “SELF-CONFIGURING SYSTEMS” that was filed on Jun. 5, 2018 and that application is incorporated herein in its entirety by reference; this Patent Application makes reference to U.S. Pat. No. 7,715,953 (the '953 patent) by Shepard titled “TRAILER BACKING UP DEVICE AND METHOD” which issued on May 11, 2010 and U.S. Pat. No. 9,132,856, by Shepard titled “TRAILER BACKING UP DEVICE AND TABLE BASED METHOD” that issued on Sep. 15, 2015 (the '856 patent) and U.S. patent application Ser. No. 14/791,283, by Shepard titled “PORTABLE TRAILER GUIDANCE SYSTEM” that was filed on Jul. 3, 2015 (the '283 application) and U.S. patent application Ser. No. 15/275,386, by Shepard titled “IMU BASED HITCH ANGLE SENSING DEVICE” that was filed on Sep. 24, 2016 (the '386 application) and those applications are incorporated herein in their entirety by reference.

### REFERENCE TO A SEQUENCE LISTING, A TABLE, OR A COMPUTER LISTING COMPACT DISK APPENDIX

Attached hereto and incorporated herein as Appendix A, is a computer printout containing the source code for one embodiment of the present invention. This source code is described more completely herein. Pursuant to 37 CFR 1.96 (a)(2)(ii), a listing of this software code is found in an accompanying protective cover and is designated “COMPUTER PROGRAM PRINTOUT APPENDIX PURSUANT TO 37 CFR 1.96(a)(2)(ii)”

A portion of the disclosure of this patent document and its appendix contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

In various embodiments, the present invention relates to systems for guiding a trailer while backing and, in particular, the present invention relates to providing data by auto-configuration to systems for guiding a trailer while backing.

### BACKGROUND

Trailers have been around for many years, yet every summer and winter one can observe the owners of boats and snowmobiles, respectively, backing up those devices on trailers with great difficulty. The problem arises from the fact that a trailer being backed-up is an inherently unstable system. A trailer being pushed wants to turn around and be pulled (i.e., to jackknife) instead. To compensate for this instability, the driver must skillfully alternate the direction of his steering so as to cause the trailer to want to turn around and be pulled from opposite sides thereby repeatedly crossing the centerline of the pushing vehicle. Various innovations have been introduced to address this problem in whole or in part. Prior art reveals several attempts to address the problems associated with backing a trailer. The simplest solutions address parts of the problem ranging from ways of sensing the angle of the hitch (see: Kollitz, U.S. Pat. No. 4,122,390), to sensing and displaying the angle of the hitch (see: Gavit, U.S. Pat. No. 3,833,928), to sounding an alarm when a jackknife condition exists or is imminent (see: Kimmel, U.S. Pat. No. 4,040,006). While these solutions are helpful, they only each address a part of the backing problem. Shepard in his U.S. Pat. No. 7,715,953 teaches a complete working system. In that patent, Shepard teaches “The calculations require that certain measurements of the vehicle-trailer system are known and/or have been input into the system including the wheel base, Ω, the hitch length, Ω′, and the trailer length, L.” Storing a parameter such as the trailer length in a controller located in the trailer is a long practiced approach (see: Kimbrough, U.S. Pat. No. 5,579,228, issued Nov. 26, 1996, wherein it is taught: “On the trailer are located a steering controller/observer unit 6 . . . . Parameters can be input into a controller/observer unit 6 when the vehicle system is initialized . . . . The steering variables are defined as: . . . s—the longitudinal distance from the trailer wheels to the trailer hitch” i.e., the trailer length).

Trailer guidance systems such as the portable system disclosed in U.S. patent application Ser. No. 14/791,283, by Shepard titled “PORTABLE TRAILER GUIDANCE SYSTEM” that was filed on Jul. 3, 2015 require sensors for detecting the hitch angle and the turning radius and output means for displaying the intended trailer destination. Most vehicles do not have integral turning sensors and most trailers and/or hitches do not have integral hitch angle sensors. A solution is to make a steering wheel sensor from which the turning radius can be determined and a hitch angle sensor that can be added to an existing vehicle and trailer. However, such a system will still require that certain numerical values be inputted and some of these required values can be hard to find for a particular vehicle. Furthermore, it is anticipated that the present invention will often be used in close proximity with other users of the same system and an easy way to distinguish wireless sensors is necessary.

### SUMMARY

The present invention relates to entering data into a trailer backup guidance system 300 (see FIG. 3), and in particular, having the system determine the required data values with limited effort by the user. For such a system to operate as described in the '953 patent, the wheelbase 309 of the vehicle 301 and the length 310 of the trailer 302 must be known to the system. However, the '856 patent introduced a technique whereby a table lookup function was implemented wherein the table was configured for the units of measure being a trailer of known length and the trailer was given a length of 1 for all implementations, resulting in no trailer length being used except to enable inputting the tow vehicle's wheel base measured in these units of measure of a trailer of known length. As a result, the trailer length is not required (it always has a length of 1, regardless of how long the trailer is) whereas the wheelbase, measured as multiples of the trailer, is necessary for operation. When used in conjunction with the '283 application, the Steering Ratio must also be available to the system to enable computing turning radius by computing the angle of the front tires 308 for a given position of the steering wheel 100.

It is an objective of the present invention that entering the data for system operation can be done semi-automatically. Using teachings from the '386 application whereby a steer sensor 101 comprising an Inertial Measurement Unit (IMU) and a hitch sensor 200 comprising an IMU (or, from the teaching of the '856 patent, comprising a rotation sensor that further comprises a potentiometer or a magnet rotation sensor) can determine the angle of articulation at the hitch ball 307 (i.e., the hitch angle), the system can figure out many of its own data inputs during initialization.

In addition to these input values, the trailer backup guidance system described in the above patents or patent applications, and in particular as described in the '283 application, requires the user to select a wireless connection to the steer sensor and, in most cases, to the hitch sensor. However, when the system is used in close proximity with other users using the same system or parts of the same system (e.g., if two trailers equipped with hitch sensors are in close proximity) the user may have difficulty selecting the intended trailer's sensor. For example, a Bluetooth based link can uniquely identify a steer sensor by its MAC address, but a user will not typically know what this MAC address is. Rather than have the user figure out what his or her sensor's MAC address is, this value too can be ascertained to a significant extent by the system.

It is an objective of the present invention to simplify the collection and/or identification of these input values by enabling the system to estimate the values rather than require the user seek out these values and then input them and to minimize computations by the system.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawing, in which:

FIG. 1 depicts a steering wheel sensor in accordance with one embodiment of the invention.

FIG. 2 depicts a hitch angle sensor in accordance with one embodiment of the invention.

FIG. 3 depicts the trailer backup system in accordance with one embodiment of the invention.

FIG. 4 depicts an IMU device as used in an embodiment of the invention.

FIG. 5 depicts an overhead view of a vehicle towing a trailer in an arc and the associated physics.

FIG. 6 depicts a display screen showing selection on a list of advertising sensors in accordance with one embodiment of the invention.

FIG. 7 depicts a subroutine for determining the steering wheel multiplier for the steering linkage of a vehicle relating steering wheel angle to front wheel angle as used in an embodiment of the invention.

FIG. 8 shows a graph depicting the relationship between steering wheel rotation and front wheel angle for two steering implementations.

### DETAILED DESCRIPTION

The present invention relates to systems for guiding a trailer while backing and in particular to gathering data for operating systems for guiding a trailer while backing.

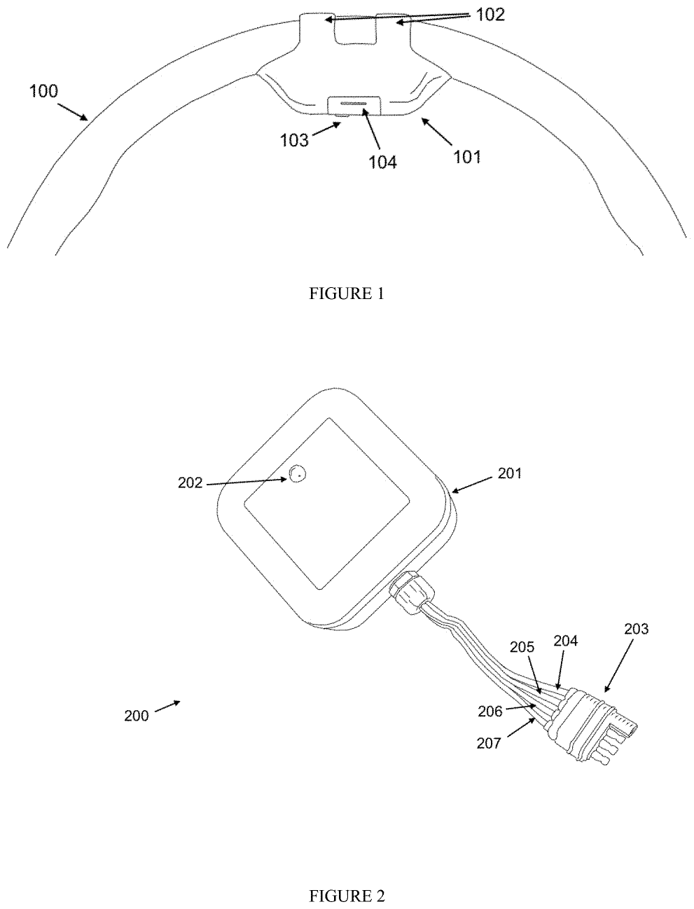

FIG. 1, illustrates the top portion of a steering wheel 100 on which a steering sensor 101 comprising an IMU has been attached using straps 102.

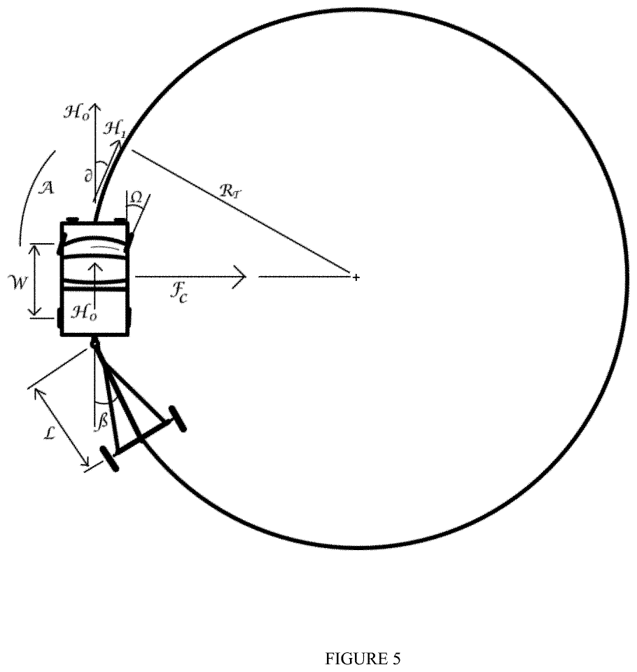

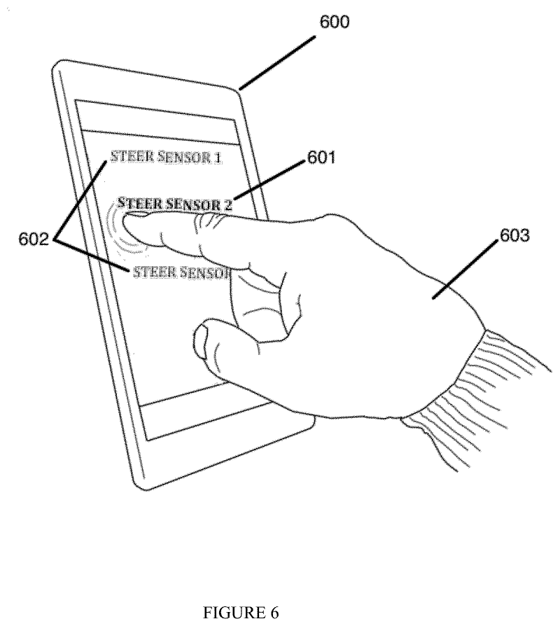

Referring to FIG. 5, when a vehicle drives forward while towing a trailer around a curve having a constant turning radius, the trailer will come to follow behind the tow vehicle and the turning radius of the trailer will become generally equal to the turning radius of the vehicle. To achieve this state, the vehicle is driven forward in a generally constant arc, A, at a generally constant rate while towing a trailer. This forward driving is continued until the trailer self-adjusts to where it is following the vehicle on generally the same turning radius. The system can verify that this state has been reached by checking that the hitch angle value is not changing (or by verifying that the hitch angle variance is below a threshold value) as the vehicle drives forward and can notify the driver that this state has been reached by lighting an LED 104. The turning radius of the trailer can be calculated as:

turningRadius_{TRAILER}=trailerLength/Tan(β)

where β is the hitch angle formed by the centerline of the vehicle and the centerline of the trailer at the hitch ball.

The angle of the front tires, Ω, can be determined by measuring the amount of rotation of the steering wheel away from its position for driving straight and multiplying this steering wheel rotation by the steering wheel multiplier:

Ω=steeringWheelMultiplier*steeringWheelRotation

This steering wheel multiplier comes from the steering ratio. By way of example, a steering ratio of 18 means that for every 18 degrees of rotation of the steering wheel, the front tires will turn 1 degree. The steering wheel multiplier in this example is 1/18 (1 over steering ratio). The steering wheel multiplier (as well as the steering ratio derived directly therefrom) can be determined from the gear ratio of the steering mechanism in the vehicle (e.g., from the rack and pinion tooth counts).

However, the angle of the front tires is also related to the wheel base and turning radius by the equation:

Tan(Ω)=wheelBase/turningRadius

So, from the preceding two equations, the following equation can be derived:

steeringWheelMultiplier=Tan⁻¹(wheelBase/(trailerLength/Tan(β)))/steeringWheelRotation

or:

steeringWheelMultiplier=Tan⁻¹(wheelBase/turningRadius_{TRAILER})/steeringWheelRotation

One of the easier values to find for a vehicle is the wheelbase—it is found in the owner's manual of almost every vehicle (whereas the steering ratio sometimes is not). This value is input into the system by the user. Then, with wheelbase available, with turning radius computed as described below, and with steering wheel rotation simultaneously measured by the steer sensor, it is possible to compute the steering wheel multiplier. Because the steering wheel multiplier is fixed in the factory for a given vehicle, once it is determined, it as can be stored (e.g., in the steer sensor or elsewhere) along with the wheel base for that vehicle and not have to be recomputed for that vehicle.

It must be noted that, in spite of the preceding mathematics and the tire angle drawing in FIG. 5, this arithmetic is ignoring the difference between the sharper angle of the wheel closer to the center of the arc and the less sharp angle of the wheel away from the center of the arc and instead computes an effective tire angle by this approach. It should also be noted that an additional contributor to the turning radius at the hitch ball of a vehicle is the length of the hitch (i.e., the distance from the rear axle to the hitch ball). The above calculation relating turning radius to wheelbase and Ω computes the turning radius to the effective tire path (turningRadius_{TP}). Vehicle turning radius, as described in the '953 patent, is more precisely calculated:

turningRadius_{TP}=(wheelBase/Tan(Ω))

adjustedTurningRadius=squareRoot(turningRadius_{TP}²+hitchBallLength²)

where hitchBallLength is the distance from the rear axle to the hitch ball. When the front wheels are not turned sharply, turningRadius_{TP} is nearly equal to adjustedTurningRadius. The present invention contemplates using either method for calculating the turning radius of the vehicle.

The turning radius of the vehicle can also be determined without towing a trailer. Using the combined teachings from the '386 application and the '283 application, an Inertial Measurement Unit (IMU) type rotation sensor is attached to the steering wheel having 9 Degrees of Freedom (9 DoF). These degrees of freedom can be obtained by three-axis accelerometers, gyroscopes, and magnetometer sensors (see FIG. 4) such as found in a certain MEMS IMU component (e.g., part number IMU-9250 as is available from a company called InvenSense). This 9 DoF IMU will enable the measurement of the rotation angle of the steering wheel. As is well known and understood by those familiar with IMU's and with Quaternion Matrix Algebra, an IMU so mounted can be initialized to track its real world heading relative to magnetic north and its vertical orientation to gravity in order to provide a heading angle (i.e., rotation about the gravity vector) as well as the rotation of the steering wheel (via Euler Angles). In addition, the accelerometers can be used to derive the lateral acceleration when the vehicle is traveling in an arc (i.e., centripetal force).

Well known equations for motion can be used to derive the turning radius of the vehicle. Referring to FIG. 5, as a vehicle having a wheel base, W, is driven forward in a generally constant arc, A, (i.e., the steering wheel is held in a fixed position with a non-changing angle of rotation) at a generally constant rate, the IMU in the steer sensor 101 (and, optionally, any wirelessly connected computing equipment) will collect a plurality of data points, each data point comprising a measurement of the heading, H, the centripetal force, F_{c}, the steering wheel rotation, and the time stamp. The data points are examined to identify a time period, Δt, during which the magnitude of the centripetal force is generally constant (or where the variance in the data is below a threshold value). This examination can be done in real time as the data is collected or after data collection is completed. (If no qualifying data segment is found, the process must be repeated until qualifying data is found.) From this identified segment of the data points, the change in heading is calculated as the difference between the final heading, H₁, and the initial heading, H₀. This change in heading, H₁− H₀, is then divided by its corresponding time interval, Δt, to determine the angular velocity, ν, during that time period:

ν=(H₁−H₀)/Δt

The vehicle's turning radius, R_{T}, is then found by dividing the centripetal force (or the average of the centripetal force data during the time interval if a variance threshold approach is used) by the angular velocity squared:

R_{T}=F_{c}/ν².

Using the wheel base value that was inputted, the just computed value for turning radius, and the generally non-changing angle of rotation of the steering wheel, the steering wheel multiplier is found as:

steeringWheelMultiplier=Tan⁻¹(wheelBase/R_{T})/steeringWheelRotation

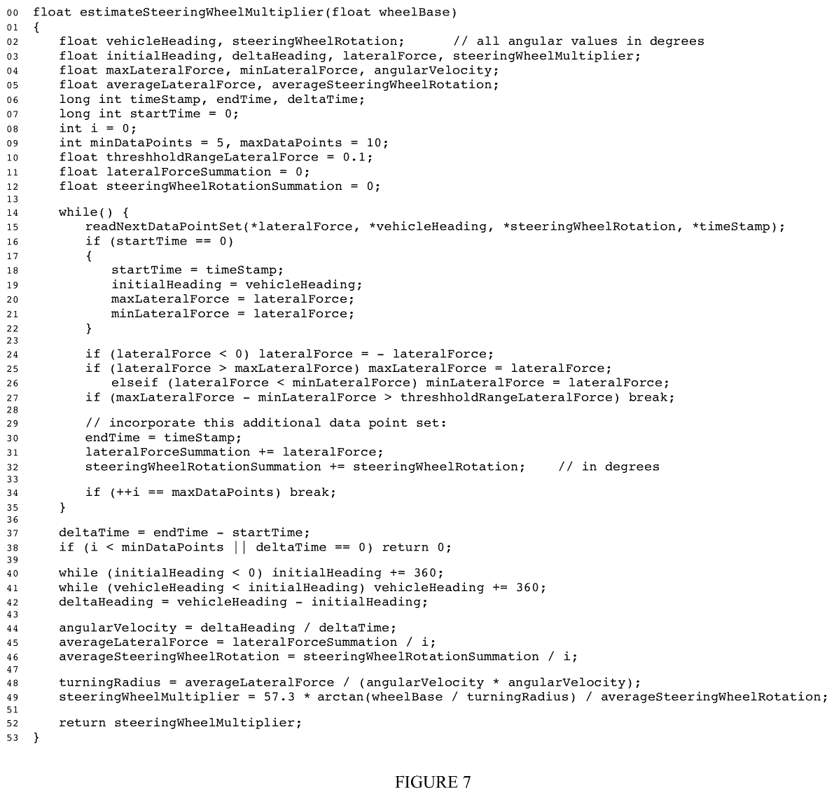

FIG. 7 shows an example of a subroutine to implement the present invention. Highlights in the code include: at line 15 a function that returns the next consecutive set of data points including lateral or centripetal force, the vehicle heading, the rotational position of the steering wheel, and the time stamp; at line 24-27 code to ensure lateral force values are within range of a threshold (to confirm that vehicle speed is generally constant); lines 31 & 45 and 32 & 46 compute average of lateral force and of steering wheel rotation, respectively; lines 37, 42 & 44 compute angular velocity; line 48 computes turning radius; line 49 computes the steering wheel multiplier (57.3 converts radians returned from arctan function to degrees).

It is also contemplated as being within the spirit and scope of the present invention that if any one or more values are provided as inputs to the system from a user or provided by other means, the other portions of the above teaching can still be used to solve for the missing values.

As the vehicle is driven forward in a generally constant arc at a generally constant rate as described above, the turning radius for the trailer (measured to its center axis which runs from the hitch ball coupler to the point at the average center between the tires) can also be computed from the hitch angle, β, and the trailer length as:

Tan β=trailerLength/turningRadiusₜ or turningRadiusₜ=trailerLength/Tan β

Likewise, the turning radius for the vehicle can be computed from the angle, Ω, of the vehicle's front tires and its wheel base as:

Tan Ω=wheelBase/turningRadiusᵥ or turningRadiusᵥ=wheelBase/Tan Ω

When a vehicle tows a trailer around a constant curve, the trailer will come to follow behind the tow vehicle and the turning radius of the trailer will become equal to the turning radius of the vehicle (i.e., turningRadiusₜ=turningRadius_{y}=turningRadius), producing the equation:

trailerLength/Tan β=wheelBase/Tan Ω

from which one can derive:

wheelBase/trailerLength=Tan Ω/Tan β

Finally, from the '856 patent, measurement is done using the length of the trailer as the yardstick resulting in the trailer length always being equal to 1, so one can now recognize that the wheel base of the vehicle equation can be simplified:

wheelBase/1=Tan Ω/Tan β

or, with the trailer as the yardstick, the wheel base measured in units of trailer length:

wheelBase=Tan Ω/Tan β

The hitch angle, β, is measured directly by the steer sensor (i.e., as described in the '953 patent or the '386 application). The angle of the front tires, Ω, is determined by directly measuring the amount of rotation of the steering wheel away from its initial, straight ahead position and multiplying that angular change of rotation by the steering wheel multiplier:

Ω=steeringWheelMultiplier*steeringWheelRotation

In addition to values such as trailer length, wheel base, steering ratio and/or steering wheel multiplier being input or estimated, the trailer backup guidance system described in the above patent or patent applications, and in particular as described in the '283 application, requires the user to also select a wireless connection to a steer sensor and, in most cases, to a hitch sensor if not a wired connection.

A computer program can be written in the Java programming language (as shown in Appendix A, filed with the present application) for a “SteeringRatioEstimator” class for determining the steering wheel multiplier of the steering linkage of a vehicle relating steering wheel angle to front wheel angle as used in an embodiment of the invention when the vehicle is towing a trailer. An instance of this class, as shown in the appendix, is initialized by providing it with (a) the threshold values for steering wheel rotation, hitch angle, and yaw of the vehicle and (b) parameters of the vehicle and trailer (wheel base, hitch length, trailer length, and an initial guess of the steering ratio). Thereafter, data samples each containing steering wheel rotation, hitch angle, and yaw are provided for averaging. When driving forward in a circle while towing, the trailer will follow behind the vehicle but will need to be pulled for some distance in order to find that position behind the vehicle. Typically, for this to happen, the vehicle is driven on a constant turning radius. Due to normal variability and noise when reading steering wheel rotation or hitch angle, the SteeringRatioEstimator class will monitor the data samples to make sure the inputs for steering wheel rotation and hitch angle are within their threshold values. This is to validate (i) that the vehicle is traveling on a generally constant turning radius path and (ii) that the trailer has settled into its position behind the vehicle (where the trailer is traveling along the same turning radius as the vehicle) such that the hitch angle is generally constant. The vehicle's yaw is monitored to validate that the vehicle has progressed at least a minimum distance around the circle as dictated by the vehicle's turning radius by checking that the vehicle's angular change in heading (Δyaw) exceeds the provided threshold value for yaw change.

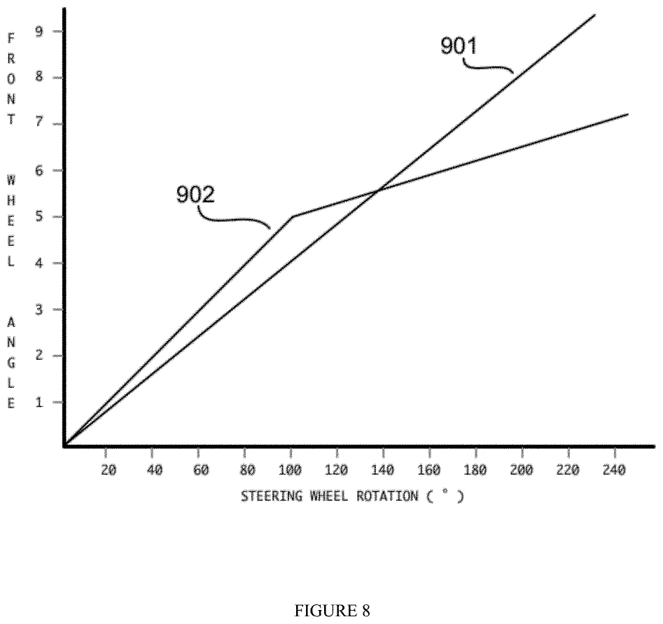

Refer now to FIG. 8 for a variation on the present invention. FIG. 8 shows a graph depicting the relationship between the steering wheel rotation and the front wheel angle for two vehicles. The first vehicle, as represented by line 901, has a direct steering ratio of about 25:1. However, the second vehicle, as represented by line 902, is not perfectly linear and has a first steering ratio of about 20:1 for steering wheel rotations between 0 degrees and 100 degrees, but above the changeover point (CP) at 100 degrees, has a second steering ratio of about 60:1 (admittedly, not necessarially a realistic value, but suitable for discussion of the present invention). First, a steering ratio estimation is made with a steering wheel rotation corresponding to a steering ratio below the changeover point. This can be done by making two estimations corresponding to two different steering wheel rotations (these can be determined experimentally) and verifying that they are roughly equal; this will confirm that both estimates were made below the changeover point without having to know where the actual changeover point is. Next, the steering wheel rotation is increased and an estimate is made to verify the steering ratio is now above the changeover point (again, this can be determined experimentally). Finally, the steering wheel rotation is increased and one more estimate is made of the steering ratio. At this point, (A) the steering ratio below the changeover point will be known (from data point s₀) and (B) two data points (s₁ and s₂) above the changeover point will be known. Using the two data points above the changeover point, the slope of the top part (the part corresponding to that portion above the changeover point) of a plotted line similar to plotted line 902 can be calculated. The slope (m_{CP}) is:

$${m}_{CP} = \frac{( \begin{matrix}( front wheel angle from {s}_{2} ) - \\ ( front wheel angle from {s}_{1} )\end{matrix} )}{( \begin{matrix}( steering wheel rotation from {s}_{2} ) - \\ ( steering wheel rotation from {s}_{1} )\end{matrix} )}$$

and the changeover point on the graph (s_{CP}) is:

(front wheel angle at s_{CP})=m_{CP}×(steering wheel rotation at s_{CP})+b

where b is:

b=(front wheel angle at s₂)−m_{CP}×(steering wheel rotation at s₂)

The slope (m₀) of the lower part (the part below the changeover point) is:

$${m}_{0} = \frac{( \begin{matrix}( front wheel angle from {s}_{2} ) - \\ ( front wheel angle from {s}_{1} )\end{matrix} )}{( \begin{matrix}( steering wheel rotation from {s}_{2} ) - \\ ( steering wheel rotation from {s}_{1} )\end{matrix} )}$$

and the changeover point on the graph (s_{CP}), determined along the lower part is:

(front wheel angle at s_{CP})=m₀×(steering wheel rotation at s_{CP})

from which it can be determined:

m₀×(steering wheel rotation at s_{CP})=m_{CP}×(steering wheel rotation at s_{CP})+b

and:

m₀×(steering wheel rotation at s_{CP})−m_{CP}×(steering wheel rotation at s_{CP})=b

and:

(steering wheel rotation at s_{CP})×(m₀−m_{CP})=b

giving:

steering wheel rotation at s_{CP}=b/(m₀−m_{CP})

The above procedure can be extended for vehicles wherein the steering ratio has multiple changeover points. Even if the actual steering ratio is a curved function, a plurality of steering ratio estimates could be taken to form an approximated curve as is well understood by those skilled in algebra.

Note that the graph in FIG. 8 shows only the top right quadrant representing positive steering wheel rotation and front tire turning. Negative steering wheel rotation and front tire turning can be ascertained by changing the sign of the values on both axes.

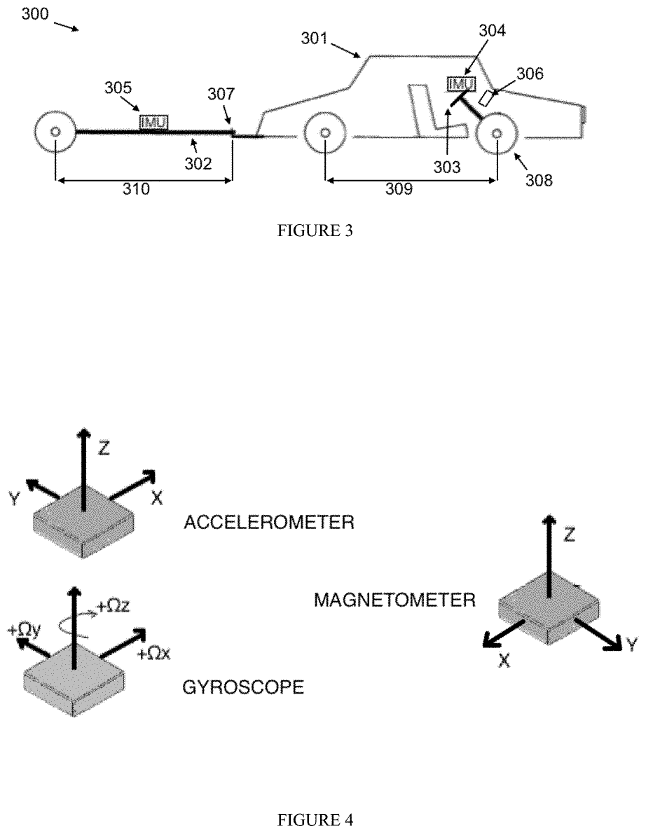

A display 306 to interact with the steer sensors 101 and hitch sensor 200 is a necessary part of a trailer backup guidance system 300 (see FIG. 3). Typically, this display is a hand-held or a portable device (such as a smart phone like an iPhone or a tablet like an iPad, or some other portable or mobile device such as a laptop computer, or a portable computer) that is wirelessly connected to the trailer backup system sensors. For a wireless display device, the wireless link could be affected using WiFi, Bluetooth, ZigBee, or any of a number of commercially available wireless protocols or a proprietary protocol using the same or other radio, visible light, invisible light communications. This display component will communicate with other components of the system such as the electronics proximate to the hitch to contribute to the determination of the hitch angle, electronics proximate to the steering to contribute to the determination of the turning radius of the vehicle, or other electronics or computing components for performing calculations or otherwise contributing to the determination of the trailer's predicted direction. For components to become connected, they identify each other wirelessly and form an association. Once the communication links are formed, guidance can commence.

However, when the system is used in close proximity with other users using the same system or parts of the same system (e.g., if one or more other trailers equipped with a similar hitch sensor is in close proximity to the trailer being towed), it can be difficult to identify the intended sensor. For example, a Bluetooth based link can uniquely identify a steer sensor by its MAC address, but a user will not typically know what his steer sensor's MAC address is. Rather than have the user figure out what his or her sensor's MAC address is, this value too can be ascertained to a significant extent by the system. By having the user operate some form of input such as button 103 on the steer sensor 101 or the break lights or turn signals of a vehicle 301 connected to a hitch sensor 200, a particular sensor can be identified in a list of sensors on a display unit 306 (e.g., a smartphone or tablet or the equivalent) that is communication with that or those sensors.

When a sensor having a wireless link such as Bluetooth is powered up, it offers itself up for a connection to the other components of the system—it “advertises” its presence. A display device seeking to connect to that sensor will collect the wireless advertisements of nearby sensors for display in a list on that display device. The advertising packet sent out by the sensor may contain identifying information such as a name. Often this identifying information is in the form of a string that provides a text label that can be displayed and read. But, the communication standard also enables the packet to include other identifying information (e.g., that sensor's UUID or MAC address). However, when there are multiple sensors of the same type, especially if a plurality of the sensors are in their factory configuration and have not been personalized by the user, it can be difficult for a user to identify the intended sensor from the plurality of sensors in the list. For these situations, it is desirable for the user to be able to flag the intended sensor such that the particular sensor's name is highlighted in the list.

The sensors of the present invention have this capability. The steer sensors 101 as taught by the '283 application have a button 103 for initializing the system when the vehicle and trailer are inline with each other (see FIG. 1). This same button can be configured to only perform this initialization function after a wireless association has been made (i.e., after the system and that steer sensor have established a communication link); however, prior to this association, the button can have no effect other than to set or clear a flag bit within the sensor. This bit is made a part of and included in the advertising packet. In this way, the device seeking the connection with the sensor advertising itself, can manage its list of advertising sensors by highlighting (such as by changing the font style, bolding, italicizing, underlining, color or size, or changing the background color, pattern or border, or the entry's position in the list to an adjacent position or to a specific position such as the top, or the like) the sensor's label entry in the list of advertising sensors on the display device when the bit is set (and displaying normally the sensor's label entry in the list of advertising sensors on the display device when the bit is clear, except if the positioning type of highlighting is used, the new position in the list preferably does not get changed back). In this way, the user can toggle the button on the steer sensor to cause its entry in the list to appear to flash or to move or to otherwise be highlighted and thereby make it easier to identify that sensor's entry in the list 601 from other sensors' entry in the list 602 for easier identification and selection on the display 600 by the user 603. Other mechanisms to highlight the intended sensor in the list can include adding an icon, symbol, picture, character or other marker proximate to that list entry.

The hitch sensors 200 as taught by the '283 application can be powered via the trailer wiring harness and connector 203 (see FIG. 2). A typical trailer wiring harness is the “flat-four” cable which has four signals: ground (often a white wire 204), taillights (often a brown wire 205), left turn signal (often a yellow wire 206), and right turn signal (often a green wire 207). To provide +12 volts power, the user turns on the lights of the vehicle which energizes the taillights wire causing the hitch sensor to power up and begin advertising. The left and right turn signals are electrically connected (with appropriate voltage protection circuitry as is well known to those skilled in the art) to spare input pins of the processor in the hitch sensor. These pins are read by the processor to set or clear a flag bit (set if the left turn signal or the right turn signal or both are illuminated) within the sensor. This bit is made a part of the hitch sensor advertising packet. In this way, the device seeking the connection with the hitch sensor advertising itself, can manage its list of advertising hitch sensors by highlighting (in similar fashion to the highlighting options described above for the steer sensor). In this way, the user can repeatedly depress and release the break peddle to signal the hitch sensor to toggle the flag bit which will to cause its entry in the list to appear to flash or otherwise be highlighted and thereby make it easier to identify that hitch sensor in that list. Alternatively, the left turn signal and the right turn signal can each have their own flag bit, both of which are made a part of the advertising packet to enable more complex signaling patterns based on which turn signal is illuminated (or both illuminated if the break peddle is depressed). A red-green LED 202 in the hitch sensor's enclosure 201 can also be lighted red when the left turn signal is illuminated or lighted green when the right turn signal is illuminated to verify proper sensing of the tail lights.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

I claim:

1. A parameter estimating technique for use with a backing up guidance system comprising: a vehicle that can tow a trailer, a device to determine angular velocity, and a device to determine lateral acceleration whereby angular velocity and lateral acceleration are used to calculate one or more estimated values from the list of (i) the wheel base of the vehicle, and (ii) the ratio of the turning of the steering wheel to the turning of the wheels of the vehicle, and (iii) the wheel base of the vehicle measured in units of trailer length, (iv) the length of the trailer, (v) a communication link's address or ID, and the one or more values are used to compute a direction for a trailer.

2. The parameter estimating technique of claim 1 whereby the calculation of one or more values is performed more than once with the multiple estimated values calculated then being combined for a more accurate result.

3. The values calculated of claim 2 whereby an input enables the system to use a value provided to the system either instead of the estimated value calculated or without performing the estimated value calculation.

4. The value provided to the system of claim 3 whereby the value is communicated wirelessly.

5. The value provided to the system of claim 3 whereby the value is input on a mobile device.

6. A parameter estimating technique for use with a backing up guidance system comprising: a vehicle coupled to a trailer, a system to aid guiding the trailer along a path or to a destination, a device to determine the angle of the wheels used to turn the vehicle, and a device to determine the hitch angle whereby the angle of the wheels and the hitch angle are used to calculate one or more estimated values from the list of (i) the wheel base of the vehicle, and (ii) the ratio of the turning of the steering wheel to the turning of the wheels of the vehicle, and (iii) the wheel base of the vehicle measured in units of trailer length, (iv) the length of the trailer, (v) a communication link's address or ID, and the one or more values are used to compute a direction for a trailer.

7. The calculation of the ratio of the turning of the steering wheel to the turning of the wheels of the vehicle of claim 6 further comprising the calculation or the estimation of a non-linear relationship between the turning of the steering wheel to the turning of the wheels of the vehicle.

8. The parameter estimating technique of claim 6 whereby linear measurements in the system to aid guiding the trailer along a path or to a destination are made relative to the length of the trailer.

9. The system to aid guiding the trailer along a path or to a destination of claim 8 whereby the value used to represent the length of a trailer does not change with trailers of different lengths.

10. The value used to represent the wheel base of the vehicle of claim 9 whereby an input enables the system to use a value provided to the system either instead of the estimated value calculated or without performing the estimated value calculation.

11. The value provided to the system of claim 10 whereby the value is communicated wirelessly.

12. The value provided to the system of claim 10 whereby the value is input on a mobile device.

13. The value input on a mobile device of claim 12 whereby the mobile device accepts as inputs the trailer length and the wheel base of the vehicle, recomputes the length of the wheel base to be in units of measure of trailer length, and provides the recomputed wheel base value to the system instead of the estimated value calculated by the system or without the system performing the estimated value calculation.

14. The value input on a mobile device of claim 12 whereby the value is stored by the system for computation of a value at a later point in time to be used instead of the estimated value calculated by the system or without the system performing the estimated value calculation.

15. A parameter estimating technique for use with identifying a wireless device comprising: a first device comprising an input and wireless connection circuitry, and a second device comprising a display and wireless connection circuitry whereby (a) the first device communicates identifying information to the second device, (b) the identifying information comprises information about the input, (c) the second device displays the identifying information, and (d) the second device modifies the displaying of the identifying information depending upon the information about the input.

16. The parameter estimating technique for use with identifying a wireless device of claim 9 further comprising a third device comprising an input and wireless connection circuitry whereby the third device is distinguished from the second device as a function of the difference between the modified display of the identifying information of the second device and the display of the identifying information of the third device.

17. The modification of the displaying of the identifying information of claim 9 whereby the modification comprises changing one or more of the displayed identifying information's font style, the font color, the background, or the list position.

18. The changing font style of claim 17 whereby change in font comprises changing one or more of the font's bolding, italicizing, underlining or size.

19. The changing background of claim 17 whereby change in background comprises changing one or more of the background's color, pattern or border.

20. The modification of the displaying of the identifying information of claim 9 whereby the modification comprises displaying proximate to the displayed identifying information's list entry one or more of an icon, symbol, picture, or character.
